(19) United States
(12) Patent Application Publication
(10) Pub. No.: US 2011/0049207 A1
(43) Pub. Date: Mar. 3, 2011

(54) HITCH MOUNTED CARGO CARRIER

(76) Inventor: John W. Hufgard, Akron, OH (US)

(21) Appl. No.: 12/552,342

(22) Filed: Sep. 2, 2009

(51) Int. Cl. B60R 9/10; B60R 9/06

(52) U.S. Cl. 224/510; 224/519

(57) ABSTRACT

A hitch mounted cargo carrier including a hitch member having a horizontal rail adapted to be secured in a hitch and a vertical rail and a carrier member movable relative to the hitch member between a transport position and a loading position. The vertical rail includes an aperture therethrough. The carrier member includes a sleeve slidably positioned around the vertical rail and movable relative thereto, a platform adapted to carry cargo, and a pair of brackets defining a channel. The brackets each have a teardrop shaped opening therethrough. A pin is received through the teardrop openings and the aperture through the vertical rail when the carrier member is in the transport position to secure the carrier member relative to the hitch member and prevent swaying of the platform.

### FIELD OF THE INVENTION

This invention relates to a cargo carrier adapted to be received in a hitch that is secured to a vehicle. More particularly, this invention relates to such a hitch mounted cargo carrier that is vertically movable between a loading position and a transport position, and that includes an anti-sway mechanism.

### BACKGROUND OF THE INVENTION

It is often desirable to carry cargo externally of a vehicle during transport. The need to stow cargo on the exterior of the vehicle may be due to a number of reasons, including, for example, a lack of internal cargo space and/or ease of loading and unloading the cargo. Hitch mounted cargo carriers are well suited to such a purpose and are well known in the art. Hitch mounted cargo carriers include a hitch member that is received in a hitch mounted to the vehicle and a platform or other surface or area on which the cargo may be placed.

In some instances it is also desirable for the cargo carrier platform to be capable of vertical movement between a loading position and a transport position. The loading position allows larger items such as, for example, a motorcycle to be easily positioned on the cargo carrier. The cargo carrier platform may then be raised to the transport position with the cargo already secured in place. Thus, vertical movement of the cargo carrier provides for easier and safer loading of the cargo.

A common problem associated with such cargo carriers is swaying of the carrier relative to the vehicle during transport. Uneven road surfaces and turning of the vehicle can increase these swaying problems, thereby making operation of the vehicle more difficult as well as increasing the likelihood of damage to the cargo. Conventional solutions to the swaying problem include attaching straps to the sides of the cargo carrier and to the vehicle. However, the straps often make loading and unloading of cargo more difficult and time consuming, and they are not entirely effective.

Thus, the need exists for a hitch mounted cargo carrier that is movable between a loading position and a travel position and that includes a mechanism to reduce swaying of the cargo carrier during transport.

### SUMMARY OF THE INVENTION

In light of the foregoing, it is a first aspect of the present invention to provide a hitch mounted cargo carrier including a mechanism to reduce swaying of the cargo carrier relative to a vehicle.

It is another aspect of the present invention to provide a hitch mounted cargo carrier that is vertically movable between a loading position and a transport position.

It is still another aspect of the present invention to provide a hitch mounted cargo carrier including a locking pin and a generally tear shaped opening adapted to receive the locking pin, the tear shaped opening and locking pin acting to prevent swaying of the cargo carrier relative to the vehicle.

In general, a hitch mounted cargo carrier according to the present invention includes a hitch member having a horizontal rail adapted to be secured in a hitch and a vertical rail, and an aperture through the vertical rail. The cargo carrier also includes a carrier member movable between a transport position and a loading position and including a sleeve slidably positioned around the vertical rail of the hitch member. The carrier member is movable relative to the hitch member. A platform is provided that is adapted to carry cargo, and a pair of brackets define a channel, the brackets each having a teardrop shaped opening therethrough. The cargo carrier also includes a pin, wherein the hitch member is positioned in the channel defined by the brackets and the pin is received through the teardrop openings and the aperture through the vertical rail when the carrier member is in the transport position to secure the carrier member relative to the hitch member and prevent swaying of the platform.

In accordance with at least one aspect of the present invention, a hitch mounted cargo carrier includes a hitch member adapted to be secured in a hitch, and an aperture through the hitch member. The cargo carrier also includes a carrier member secured to the hitch member and movable relative to the hitch member between a transport position and a loading position, and a teardrop shaped opening through the carrier member. A pin is also provided, the pin being positioned in the aperture and the teardrop opening to secure the carrier member to the hitch member and to prevent movement relative thereto.

### BRIEF DESCRIPTION OF THE DRAWINGS

For a full understanding of the invention reference should be made to the following detailed description and the accompanying drawings, wherein:

FIG. 1 is a rear elevational view of a hitch mounted cargo carrier secured to a vehicle according to the present invention.

FIG. 2 is a perspective view of the hitch mounted cargo carrier of FIG. 1.

FIG. 3 is an exploded view of the hitch mounted cargo carrier.

FIG. 4 is a perspective view of the hitch mounted cargo carrier in a raised transport position.

FIG. 5 is a perspective view of the hitch mounted cargo carrier in a lowered loading position.

FIG. 6 is an enlarged fragmentary view of the hitch mounted cargo carrier as indicated in FIG. 4 showing the teardropped shape opening and locking pin.

FIG. 7 is a side elevational view showing the hitch mounted cargo carrier in both a transport and a loading position.

FIG. 8 is a rear elevational view of the hitch mounted cargo carrier secured to a vehicle and having a motorcycle positioned thereon.

### DETAILED DESCRIPTION OF THE ILLUSTRATIVE EMBODIMENTS

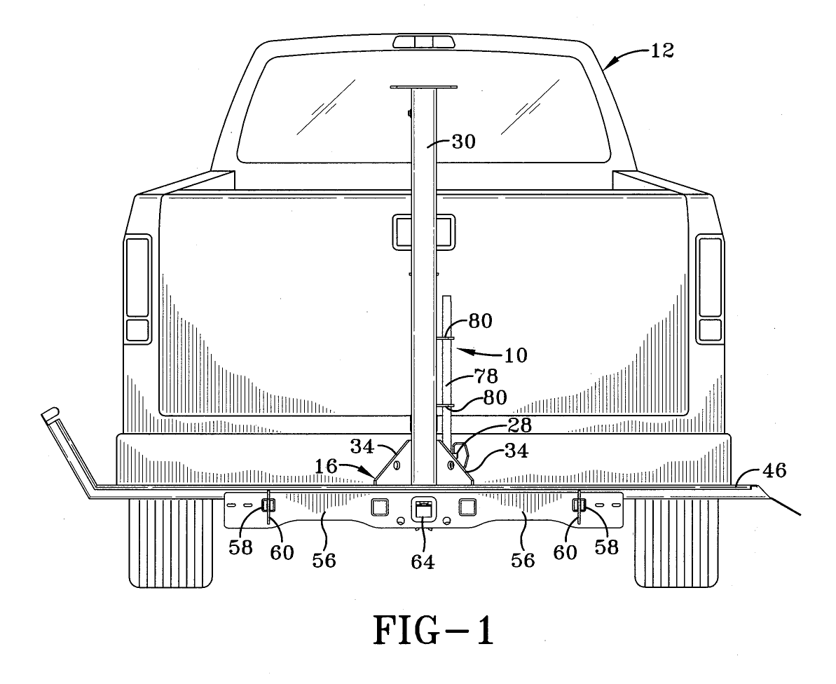

Referring now to FIG. 1, a hitch mounted cargo carrier is shown, and is generally indicated by the numeral 10. Hitch mounted cargo carrier 10 (also referred to as cargo carrier 10) is received in a hitch (not shown) that is mounted to a vehicle 12, as is known in the art. Although a conventional hitch is contemplated as a means of attachment herein, it should be appreciated that any method of securing cargo carrier 10 to vehicle 12 may be used. For example, cargo carrier 10 may alternately be secured directly to the frame of vehicle 12 by welding it thereto. Vehicle 12 may be any vehicle having a hitch mounted thereto, including, for example, a pick up truck, a moving truck, or a recreational vehicle (RV).

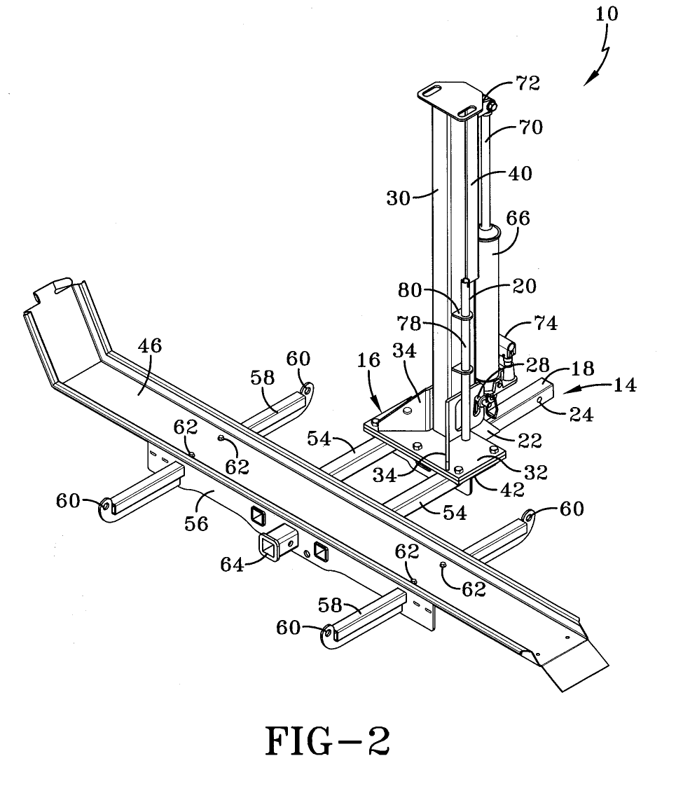

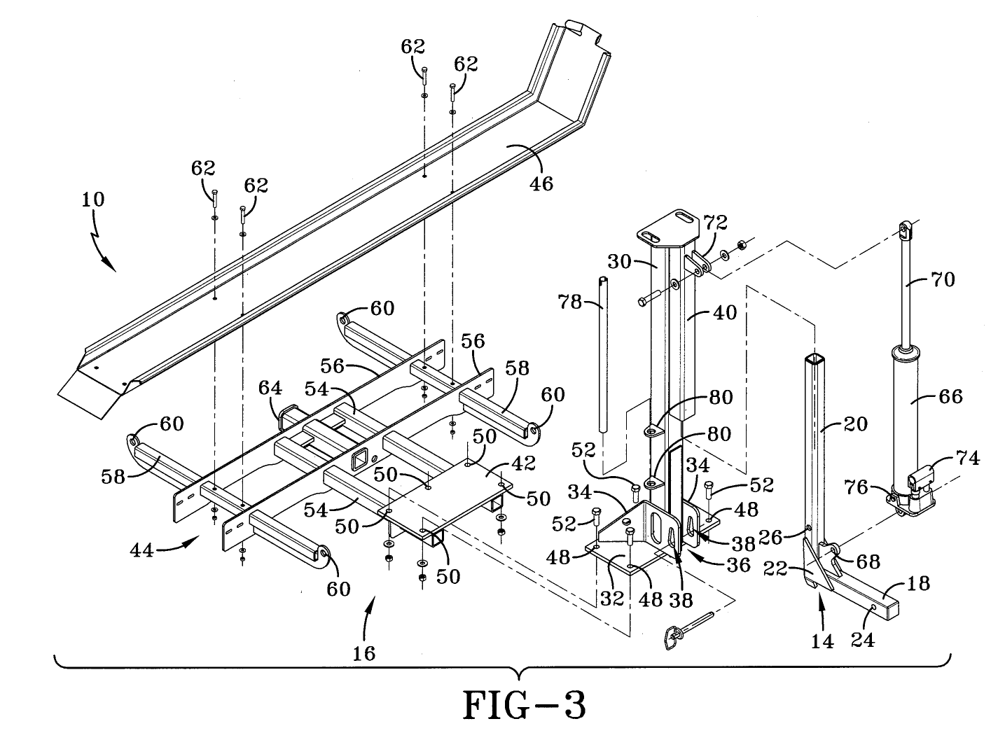

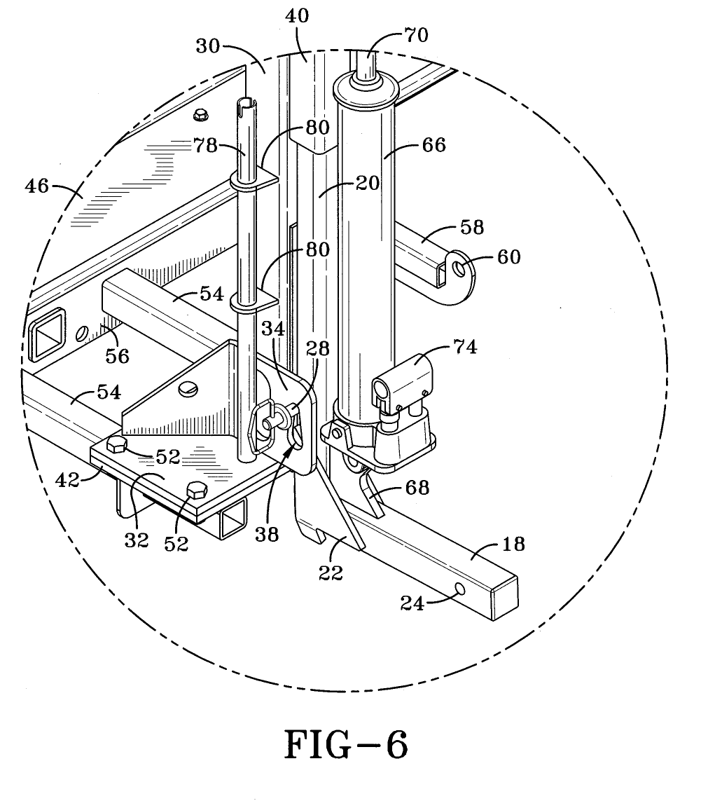

With reference now to FIGS. 2-6, cargo carrier 10 is shown in greater detail. Cargo carrier 10 includes a hitch member 14 adapted to be secured in the hitch mounted to vehicle 12, as is known in the art, and a carrier member 16 that is slidingly secured to hitch member 14 and adapted to be movable vertically relative thereto. Hitch member 14 includes a horizontal rail 18 and a vertical rail 20 extending generally perpendicular from horizontal rail 18. One or more corner support brackets 22 may be provided at the intersection of horizontal rail 18 and vertical rail 20 to strengthen hitch member 14. Horizontal rail 18 includes an aperture 24 adapted to receive a pin passing through the hitch of the vehicle (not shown) to secure hitch member 14 in the hitch. Vertical rail 20 also includes an aperture 26 adapted to receive a pin 28 which acts to lock carrier member 16 relative to hitch member 14, as will be discussed in greater detail below.

Carrier member 16 includes a vertical support tube 30 extending upwardly from a base member 32. Base member 32 may be a generally horizontally oriented plate having a planar top surface and bottom surface, the top surface being secured to vertical support tube 30. A pair of support brackets 34 are provided on opposed sides of vertical support tube 30 and are secured to both base member 32 and vertical support tube 30. Support brackets 34 each extend beyond the edge of vertical support tube 30 and base member 32 creating a channel 36 between the support brackets 34.

Each support bracket 34 also includes a teardropped shaped opening 38 adjacent to channel 36. Teardrop openings 38 each have a width at the bottom end that is greater than the width at the top end, as will be understood by those skilled in the art. Teardrop openings 38 are positioned in support brackets 34 so as to be aligned with one another, and are adapted to receive pin 28 therethrough.

A sleeve 40 is provided on one side of vertical support tube 30 and is positioned above channel 36. Sleeve 40 is oriented vertically and is sized and shaped to receive vertical rail 20 of hitch member 14 therein. In order to allow vertical movement of carrier member 16 relative to hitch member 14, at least a minimal amount of clearance is provided between the exterior surface of vertical rail 20 and the interior of sleeve 40. The specific amount of clearance is not critical so long as vertical rail 20 can move within sleeve 40 without a significant amount of frictional resistance. This clearance, if not accounted for, is what allows for some swaying of carrier member 16 relative to hitch member 14.

Base member 32 is attached to a plate 42 of a platform frame 44, which supports a platform 46. Base member 32 includes a plurality of holes 48, and plate 42 includes a plurality of holes 50 sized and positioned to align with holes 48. A mechanical fastener 52 passes through each pair of aligned holes 48, 50 to secure platform frame 44 to base member 32.

Platform frame 44 includes a pair of extension tubes 54 secured to and extending from plate 42. A pair of laterally spaced ribs intersect extension tubes 54 at approximately right angles. A platform support tube 58 passes through each of the distal ends of ribs 56 and each support tube 58 is positioned generally orthogonally to the ribs 56. Each end of platform support tubes 58 includes a hook or opening 60 to facilitate the attachment of straps, as will be discussed in greater detail below. Platform 46 rests on and is secured to support tubes 58 by mechanical fasteners 62. A secondary hitch 64 may also be provided opposite plate 42 of platform frame 44 so that a trailer or other tow behind cargo carrying device may be pulled behind vehicle 12.

A linear actuator 66 is secured to an actuator mounting bracket 68 on hitch member 14. Although a hydraulic linear actuator is contemplated, it should be appreciated that any known type of linear actuator may be used, such as, for example, a pneumatic or jack screw linear actuator. The actuator arm 70 of linear actuator 66 is secured to a mounting bracket 72 extending from sleeve 40. As will be appreciated by those skilled in the art, linear actuator 66 includes a pump mechanism 74 used to introduce pressure within actuator 66 and cause extension of actuator arm 70. In addition, a release valve 76 is used to release pressure from within actuator 66 and cause contraction of actuator arm 70. An actuator rod 78 is provided and is adapted to be received by pump mechanism 74, and to fit over release valve 76, and is used with both to cause movement of actuator arm 70. Actuator rod 78 may be secured to cargo carrier 10, such as by providing attachment brackets 80 extending from vertical support tube 30 that receive actuator rod 78 therein.

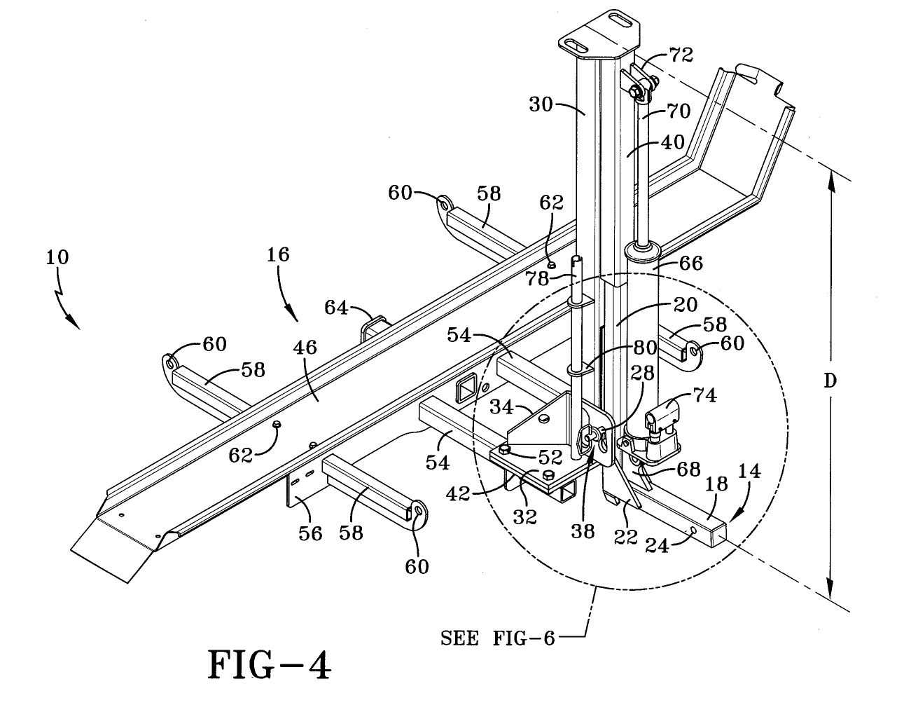

Referring now to FIG. 4, carrier member 16 is shown in a transport position. When in the transport position, actuator arm 70 is extended from linear actuator 66 causing vertical support tube 30 and sleeve 40 to be raised relative to hitch member 14. Platform 46 is also raised due to its connection through platform frame 44 and base member 32 to vertical support tube 30. Thus, when in the transport position, platform 46 is approximately at the same height as horizontal rail 18 of hitch member 14, and the top of vertical support tube 30 is displaced from horizontal rail 18 by a distance D. In order to secure carrier member 16 at the transport height D, pin 28 is inserted through teardrop openings 38 and through aperture 26 in vertical rail 20. As a result, and as will be appreciated by those skilled in the art, carrier member 16 cannot be lowered relative to hitch member 14 during transport due to the presence of pin 28.

The weight of carrier member 16, including the weight of any cargo thereon, causes support brackets 34 to be pressed downward onto pin 28. The shape of teardrop openings 38, with a width at the upper end that is less than the width at the lower end, causes support brackets 34 to “lock” onto pin 28. In one or more embodiments of the invention, the width of teardrop openings 38 at the top end is approximately equal to but slightly larger than the diameter of pin 28, thereby allowing for little to no movement of support brackets 34 relative to pin 28. In other embodiments, the width of teardrop openings 38 at the top end may be smaller than the diameter of pin 28.

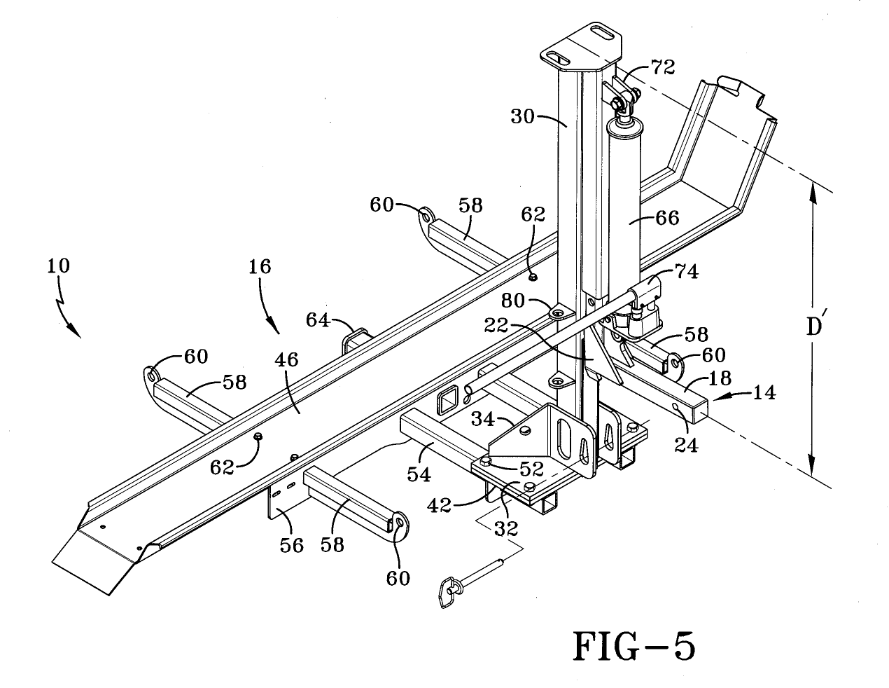

Carrier member 16 is shown in a loading position in FIG. 5, where actuator arm 70 is retracted into linear actuator 66. As a result of the downward movement of actuator 70, platform 46, sleeve 40, and vertical support tube 30 are all lowered relative to hitch member 14. In the loading position the top of vertical support tube 30 is displaced from horizontal rail 18 of hitch member 14 by a distance D′, with D′ being less than the displacement D in the transport position as shown in FIG. 4. In order to allow carrier member 16 to be moved to the loading position as shown in FIG. 5, pin 28 must be removed from aperture 26 and teardrop openings 38. Removal of pin 28 allows hitch member 14 to slide through channel 36 and into sleeve 40.

When loading of cargo is complete and platform 46 is to be moved back to the transport position shown in FIG. 4, actuator rod 78 is inserted into pump mechanism 74 and is used to introduce pressure into linear actuator 66, thereby causing actuator arm 70 to extend. As will be appreciated by those skilled in the art, extension of actuator arm 70 causes upward movement of vertical support tube 30 and platform 46 through the interconnecting structure. When platform 46 has been returned to the transport position shown in FIG. 4, pin 28 may be inserted through teardrop openings 38 and aperture 26 in vertical rail 20, thereby again securing carrier member 16 in the transport position. After pin 28 is inserted through teardrop openings 28 and aperture 26, pressure within linear actuator 66 may be removed, thereby allowing carrier member 16 to drop until pin 28 is engaged by the upper end of the teardrop openings 38.

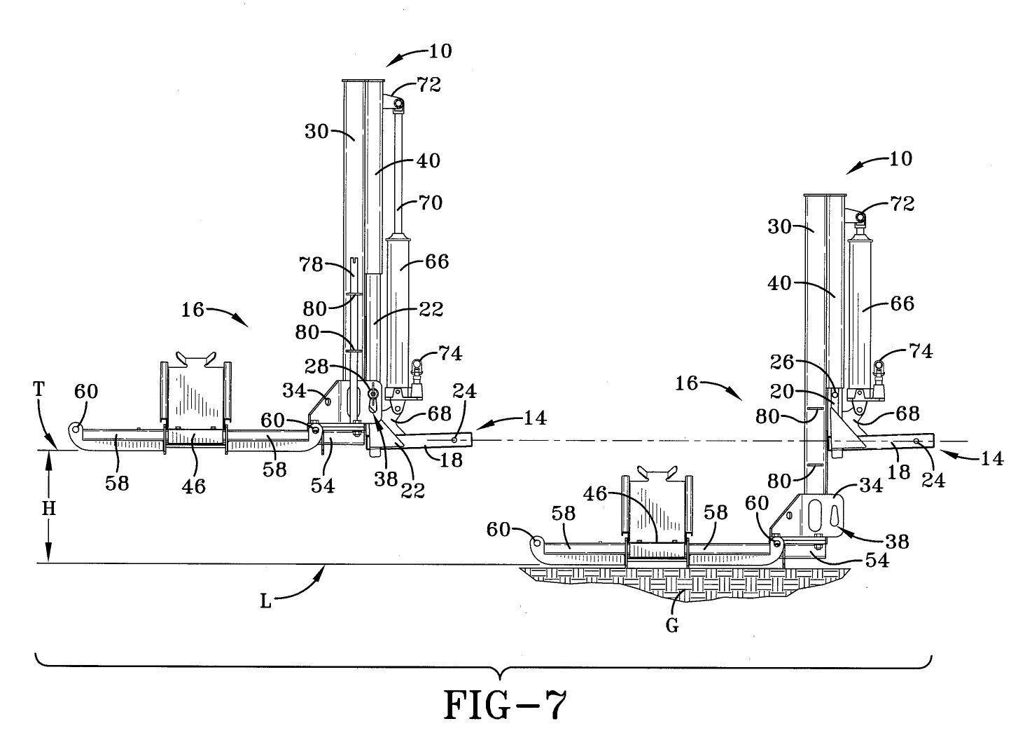

The vertical movement of carrier member 16 relative to hitch member 14 is more clearly depicted in FIG. 7. Carrier member 16 and platform 46 are shown in the transport position having a height T relative to the surrounding ground surface. While carrier member 16 is in the transport position the platform 46 is approximately level with horizontal rail 18 of hitch member 14. The height T in the transport position allows vehicle 12 to travel without any significant danger of cargo carrier 10 contacting a ground surface. Carrier member 16 is also shown in a loading position having a height L. While in the loading position the height L of platform 46 is approximately level with the ground surface thereunder. Thus, loading and unloading of cargo onto and off of platform 46 is made significantly easier and safer.

The amount of travel allowed by cargo carrier 10 may vary, but ideally is sufficient to accommodate varying heights of vehicle mounted hitches. For example, the height of a hitch on a pick-up truck may be lower than the height of a hitch on a recreational vehicle, and cargo carrier 10 is preferably adapted to lower a sufficient distance H to accommodate the higher of the hitch levels. Because carrier member 16 typically rests on a ground surface G when in the loading position, a downward stop to secure carrier member 16 in the loading position will usually not be necessary. However, such a downward stop may be provided if deemed necessary or desirable.

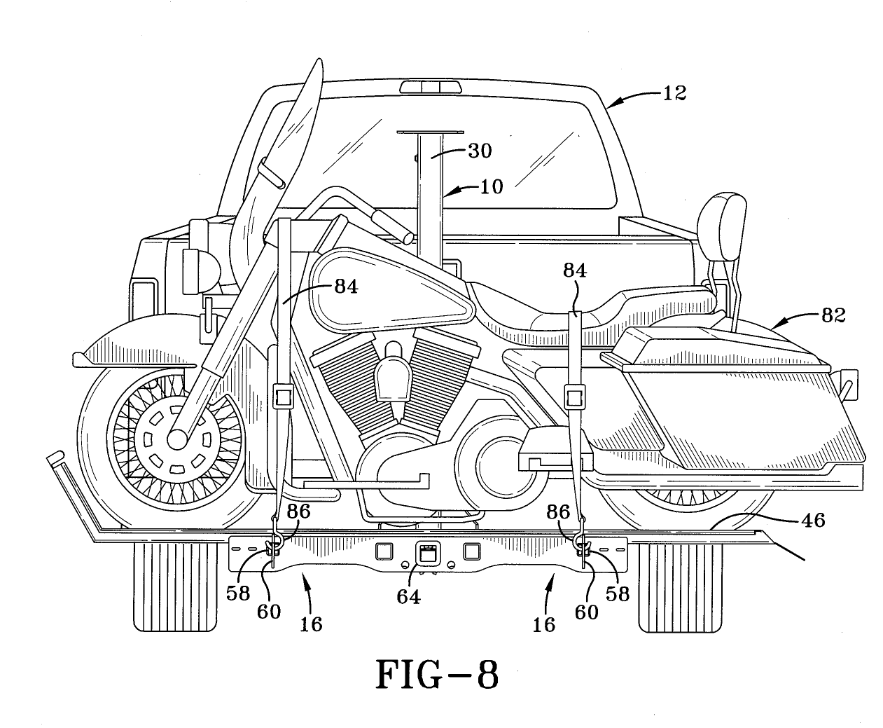

Referring now to FIG. 8, a hitch mounted cargo carrier 10 is shown attached to a vehicle 12 and having a cargo, in this case a motorcycle 82, secured thereon. Cargo carrier 10 is shown in a transport position, and motorcycle 82 is secured to platform 46 by a plurality of straps 84. Straps 84 may be any suitable straps known to those skilled in the art that are capable of securing the cargo to platform 46. Such straps are available commercially in a wide variety of forms, and may include a ratchet-like device to tighten the strap around the cargo. Straps 84 include a hook 86 at each end that is secured in hooks 60 on platform support tubes 58.

It will be apparent to those skilled in the art that when carrier member 16 is in the loading position as shown in FIG. 4, motorcycle 82 or other rolling cargo may be rolled directly onto platform 46. Alternatively, cargo may be placed onto platform 46 by hand or with the help of machinery such as a forklift. Straps 84 may than be secured over motorcycle 82 and to hooks 60 before carrier member 16 is raised to a transport position, as shown in FIG. 5, by extension of actuator arm 70 of linear actuator 66 through pump mechanism 74. Once in the transport position, pin 28 may be inserted into teardrop openings 38 and aperture 26 to secure carrier member 16 relative to hitch member 14 and prevent swaying of the cargo carrier 10 during transport.

It is thus evident that a hitch mounted cargo carrier constructed as described herein accomplishes the objects of the present invention and otherwise substantially improves the art. In accordance with the Patent Statutes, only the best mode and preferred embodiment have been presented and described in detail, and the invention should not be limited by that description. For an appreciation of the true scope and breadth of the invention, reference should be made to the following claims.

1. A hitch mounted cargo carrier comprising:
a hitch member adapted to be secured to a vehicle;
an aperture through said hitch member;
a carrier member slidably secured to said hitch member and movable relative to said hitch member between a transport position and a loading position;
an opening through said carrier member, said opening having a lower width and an upper width, said opening narrowing progressively as it extends upward in height; and
a pin positioned in said aperture and said opening, said pin securing said carrier member to said hitch member to prevent movement relative thereto.

2. The hitch mounted cargo carrier of claim 1, wherein said opening is a teardrop opening and wherein said upper width is smaller than said lower width.

3. The hitch mounted cargo carrier of claim 1, wherein said pin has a diameter, and said upper width of said opening is approximately equal to but slightly larger than said diameter of said pin.

4. The hitch mounted cargo carrier of claim 1, wherein said carrier member includes a pair of opposing brackets defining a channel therebetween, said hitch member positioned partially within said channel.

5. The hitch mounted cargo carrier of claim 4, wherein each bracket includes a teardrop shaped opening therethrough.

6. The hitch mounted cargo carrier of claim 5, wherein said pin is positioned in said aperture and said teardrop openings in said brackets.

7. The hitch mounted cargo carrier of claim 1, further comprising a linear actuator positioned between said hitch member and said carrier member.

8. A hitch mounted cargo carrier comprising:
a hitch member including a vertical rail and a horizontal rail adapted to be secured to a vehicle;
an aperture through said vertical rail;
a carrier member movable between a transport position and a loading position including a sleeve slidably positioned around said vertical rail and movable relative thereto, a platform adapted to carry cargo, and a pair of brackets defining a channel, said brackets each having a teardrop shaped opening therethrough; and
a pin, wherein said hitch member is positioned in said channel defined by said brackets and said pin is received through said teardrop openings and said aperture through said vertical rail when said carrier member is in the transport position, said pin securing said carrier member relative to said hitch member and preventing swaying of said platform.

9. The hitch mounted cargo carrier of claim 8, further comprising a linear actuator positioned between said hitch member and said carrier member, said linear actuator controlling movement of said carrier member relative to said hitch member.

10. The hitch mounted cargo carrier of claim 9, wherein said linear actuator is a hydraulic linear actuator.

11. The hitch mounted cargo carrier of claim 8, wherein said teardrop openings have a lower width and an upper width, and wherein said upper width is less than said lower width.

12. The hitch mounted cargo carrier of claim 11, wherein said pin has a diameter, and said upper width of said teardrop openings is approximately equal to but slightly larger than said diameter of said pin.

13. The hitch mounted cargo carrier of claim 8, wherein said carrier member further includes a vertical support tube secured to said sleeve and a base member secured to said vertical support tube.

14. The hitch mounted cargo carrier of claim 13, wherein said carrier member further includes a platform frame supporting said platform, said platform frame being secured to said base member.

15. The hitch mounted cargo carrier of claim 14, wherein said platform frame includes a pair of support tubes that extend beyond the edges of said platform, each said support tube including a hook at each end.

16. The hitch mounted cargo carrier of claim 9, wherein said hitch member includes an actuator mounting bracket and said sleeve includes a mounting bracket extending therefrom, said linear actuator being secured at one end to said actuator mounting bracket on said hitch member and at another end to said mounting bracket on said sleeve.
